(19) United States
(12) Patent Application Publication
(10) Pub. No.: US 2022/0396101 A1
(43) Pub. Date: Dec. 15, 2022

(54) TIRE

(71) Applicant: Sumitomo Rubber Industries, Ltd., Kobe-shi (JP)

(72) Inventors: Ryota IKEDA, Kobe-shi (JP); Hiroaki KOGA, Kobe-shi (JP)

(73) Assignee: Sumitomo Rubber Industries, Ltd., Kobe-shi (JP)

(21) Appl. No.: 17/839,484

(22) Filed: Jun. 14, 2022

(30) Foreign Application Priority Data
Jun. 15, 2021 (JP) 2021-099591
Feb. 28, 2022 (JP) 2022-029740

(51) Int. Cl. B60C 11/12; B60C 11/04; B60C 11/03

(52) U.S. Cl. CPC B60C 11/1281; B60C 11/1236; B60C 11/04; B60C 11/0302; B60C 11/0304

(57) ABSTRACT

A tire having a tread portion, wherein the tread portion can include a pair of shoulder circumferential grooves, a pair of crown circumferential grooves, and a pair of middle land portions. Each middle land portion can include a plurality of middle sipes. Each middle sipe can have a chamfered portion at at least one of sipe edges on both opposite ends thereof. The chamfered portion can extend from the crown circumferential groove to the shoulder circumferential groove. A first chamfered width of the chamfered portion at a first one of the opposite ends on a crown circumferential groove side can be greater than a second chamfered width of the chamfered portion at a second one of the opposite ends on a shoulder circumferential groove side.

### CROSS-REFERENCE TO RELATED APPLICATIONS

The present application claims priority to Japanese patent applications JP 2021-099591, filed on Jun. 15, 2021, and JP 2022-029740, filed on Feb. 28, 2022, the entire contents of each of which are incorporated herein by reference in their entirety.

### BACKGROUND

### Technical Field

The present disclosure relates to a tire.

### Background Art

Japanese Laid-Open Patent Publication No. 2019-202679 suggests a tire in which a first middle land portion and a second middle land portion each include middle sipes. According to the document, tire is expected to enhance noise performance and steering stability with its middle sipes.

Tires are required to enhance braking performance and steering stability. As one method for enhancing braking performance, for example, a method in which a sipe edge of the middle sipe is formed by a chamfered portion can be considered. The chamfered portion may allow a ground contact pressure acting on a ground contact surface of the land portion to be made uniform around the sipe. Such an effect may enhance a frictional force, in the tire circumferential direction, exerted by the land portion and may contribute to enhancement of braking performance.

However, if the width of the chamfered portion is increased in order to further enhance the above-described effect, an area of the ground contact surface of the land portion is reduced to cause deterioration of responsiveness to steering, and, consequently, steering stability may be reduced.

The present disclosure has been made in view of the above-described circumstances.

### SUMMARY

The present disclosure is directed to a tire including a tread portion. The tread portion can include four circumferential grooves extending continuously in a tire circumferential direction between two tread ends, and five land portions demarcated by the four circumferential grooves. The four circumferential grooves can include a pair of shoulder circumferential grooves, and a pair of crown circumferential grooves disposed between the pair of shoulder circumferential grooves. The land portions can include a pair of middle land portions each demarcated between a corresponding one of the shoulder circumferential grooves and a corresponding one of the crown circumferential grooves. Each middle land portion can include a plurality of middle sipes extending completely across the middle land portion in a tire axial direction. Each middle sipe can have a chamfered portion at at least one of sipe edges on both opposite ends thereof. The chamfered portion can extend from a corresponding one of the crown circumferential grooves to a corresponding one of the shoulder circumferential grooves in a tread planar view. A first chamfered width of the chamfered portion at a first one of the opposite ends on a crown circumferential groove side can be greater than a second chamfered width of the chamfered portion at a second one of the opposite ends on a shoulder circumferential groove side.

### BRIEF DESCRIPTION OF THE DRAWINGS

FIG. 1 is a development of a tread portion according to one embodiment of the present disclosure;

FIG. 2 is an enlarged view of a pair of middle land portions and a crown land portion in FIG. 1;

FIG. 3 is an enlarged view of a middle sipe in FIG. 2;

FIG. 4 is a cross-sectional view taken along a line A-A in FIG. 2;

FIG. 5 is a cross-sectional view taken along a line B-B in FIG. 2;

FIG. 6 is an enlarged view of an inner shoulder land portion in FIG. 1;

FIG. 7 is an enlarged view of an outer shoulder land portion in FIG. 1;

FIG. 8 is a plan view of a portion of a ground contact surface shape of the tire in FIG. 1;

FIG. 9 is a development of a tread portion according to another embodiment of the present disclosure;

FIG. 10 is a cross-sectional view of a middle sipe according to another embodiment of the present disclosure as taken along a length direction; and

FIG. 11 is an enlarged view of a pair of middle land portions and a crown land portion of a tire of a comparative example.

### DETAILED DESCRIPTION

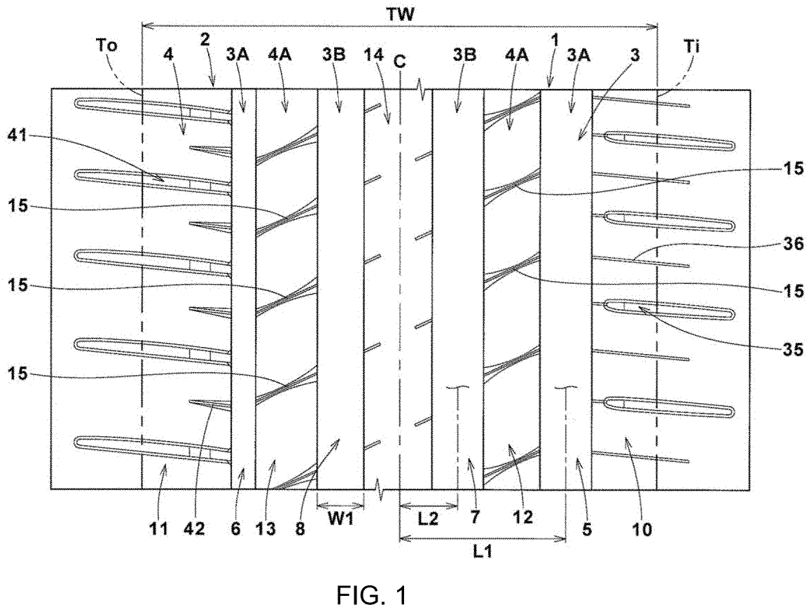

One embodiment of the present disclosure will be described below with reference to the drawings. FIG. 1 is a development of a tread portion 2 of a tire 1 according to one embodiment of the present disclosure. The tire 1 of the present embodiment can be used as, for example, a pneumatic tire for a passenger car. However, the present disclosure is not limited thereto, and may be applied to a heavy-duty pneumatic tire or a non-pneumatic tire the inside of which is not filled with pressurized air.

As shown in FIG. 1, in the present disclosure, the tread portion 2 can include four circumferential grooves 3 that extend continuously in the tire circumferential direction between two tread ends, and five land portions 4 demarcated by the four circumferential grooves 3. That is, the tire 1 of the present disclosure can be a so-called 5-rib tire in which the tread portion 2 includes the five land portions 4.

In the present embodiment, for example, the tread portion 2 has a designated mounting direction to a vehicle. Thus, the two tread ends can include an inner tread end Ti located on the inner side of a vehicle when the tire 1 is mounted to the vehicle, and an outer tread end To located on the outer side of the vehicle when the tire 1 is mounted to the vehicle. The mounting direction to the vehicle is indicated, for example, on a sidewall portion by characters or a symbol. However, the tire 1 of the present disclosure is not limited thereto, and a mounting direction to the vehicle may not necessarily be designated.

The inner tread end Ti and the outer tread end To may each correspond to the outermost ground contact position in the tire axial direction in a state where a normal load is applied to the tire 1 in a normal state and the tire 1 is in contact with a plane, for instance, at a camber angle of 0°.

The “normal state” can represent or be characterized as a state in which a tire is mounted on a normal rim and is inflated to a normal internal pressure and no load is applied to the tire, in a case where the tire is a pneumatic tire for which various standards are defined. For non-pneumatic tires and tires for which various standards are not defined, the normal state can represent or be characterized as a standard use state, corresponding to a purpose of use of the tire, in which the tire is not mounted to a vehicle and no load is applied to the tire. In the description herein, unless otherwise specified, dimensions and the like of components of the tire are represented as values measured in the normal state.

The “normal rim” can represent or be characterized as a rim that is defined by a standard, in a standard system including the standard on which the tire is based, for each tire, and is, for example, “standard rim” in the JATMA standard, “Design Rim” in the TRA standard, or “Measuring Rim” in the ETRTO standard.

The “normal internal pressure” can represent or be characterized as an air pressure that is defined by a standard, in a standard system including the standard on which the tire is based, for each tire, and is “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

The “normal load” can represent or be characterized as a load that is defined by a standard, in a standard system including the standard on which the tire is based, for each tire, and is “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard, for the pneumatic tires for which various standards are defined. For non-pneumatic tires and tires for which various standards are not defined, the “normal load” can represent or be characterized as a load that acts on one tire in a standard mounting state of the tire. The “standard mounting state” can represent or be characterized as a state in which a tire is mounted to a standard vehicle corresponding to the purpose of use of the tire and the vehicle is stationary on a flat road surface in a state where the vehicle can run.

The four circumferential grooves 3 can include a pair of shoulder circumferential grooves 3A, and a pair of crown circumferential grooves 3B disposed between the pair of shoulder circumferential grooves 3A. In the present embodiment, the shoulder circumferential grooves 3A can include, for example, an inner shoulder circumferential groove 5 disposed closest to the inner tread end Ti, and an outer shoulder circumferential groove 6 disposed closest to the outer tread end To. In the present embodiment, the crown circumferential grooves 3B can include, for example, an inner crown circumferential groove 7 disposed between the inner shoulder circumferential groove 5 and the tire equator C and an outer crown circumferential groove 8 disposed between the outer shoulder circumferential groove 6 and the tire equator C.

A distance L1 in the tire axial direction from the tire equator C to a groove center line of the shoulder circumferential groove 3A can be 25% to 35% of a tread width TW, for instance. A distance L2 in the tire axial direction from the tire equator C to a groove center line of the crown circumferential groove 3B can be 5% to 15% of the tread width TW, for instance. The tread width TW can be or represent a distance in the tire axial direction from the inner tread end Ti to the outer tread end To in the normal state.

In the present embodiment, for example, each circumferential groove 3 can linearly extend so as to be parallel to the tire circumferential direction. Each circumferential groove 3 may extend, for example, in a wavy manner.

A groove width W1 of each circumferential groove 3 can be at least 3 mm, for instance. The groove width W1 of each circumferential groove 3 can be 2.0% to 8.0% of the tread width TW, for instance. In the present embodiment, the outer shoulder circumferential groove 6 can have the smallest groove width among the four circumferential grooves 3. However, the present disclosure is not limited thereto. A depth of each circumferential groove 3 can be 5 to 10 mm, for instance, in a case where the tire 1 is a pneumatic tire for a passenger car.

In the present disclosure, the land portions 4 can include a pair of middle land portions 4A each demarcated between the shoulder circumferential groove 3A and the crown circumferential groove 3B. In the present embodiment, the pair of middle land portions 4A can include, for example, an inner middle land portion 12 and an outer middle land portion 13. The inner middle land portion 12 can be, for example, demarcated between the inner shoulder circumferential groove 5 and the inner crown circumferential groove 7. The outer middle land portion 13 can be, for example, demarcated between the outer shoulder circumferential groove 6 and the outer crown circumferential groove 8.

In the present embodiment, the land portions 4 can also include a crown land portion 14, an inner shoulder land portion 10, and an outer shoulder land portion 11. The crown land portion 14 can be demarcated between the inner crown circumferential groove 7 and the outer crown circumferential groove 8. The inner shoulder land portion 10 can be demarcated so as to be disposed outwardly of the inner shoulder circumferential groove 5 in the tire axial direction, and can include the inner tread end Ti. The outer shoulder land portion 11 can be demarcated so as to be disposed outwardly of the outer shoulder circumferential groove 6 in the tire axial direction, and can include the outer tread end To.

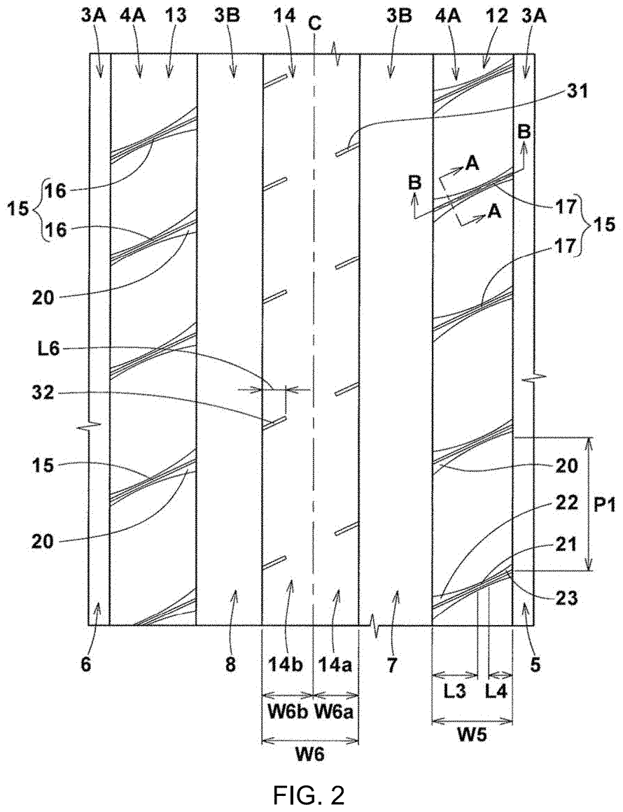

FIG. 2 is an enlarged view of the pair of middle land portions 4A and the crown land portion 14 of FIG. 1. As shown in FIG. 2, each of the middle land portions 4A can have a plurality of middle sipes 15 extending completely across the middle land portion 4A in the tire axial direction.

In the description herein, the “sipe” can be or represent a cut element having a small width such that, in a sipe body portion in which a pair of sipe walls are disposed substantially parallel to each other, a width between the two sipe walls is not greater than 1.5 mm. For instance, the width can be 0.5 to 1.5 mm. A chamfered portion having a width of greater than 1.5 mm may be connected to the opening of the sipe. A flask bottom having a width of greater than 1.5 mm may be connected to the bottom of the sipe.

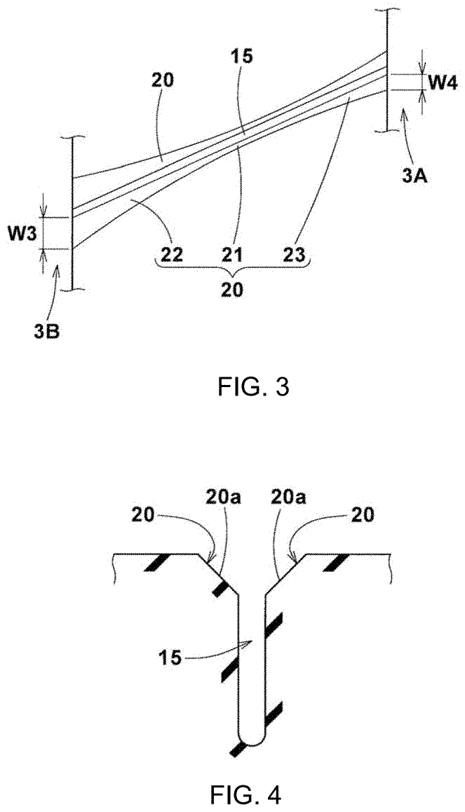

FIG. 3 is an enlarged view of the middle sipe 15 of FIG. 2. FIG. 4 is a cross-sectional view taken along a line A-A in FIG. 2. As shown in FIG. 3 and FIG. 4, the middle sipe 15 can have a chamfered portion 20 at at least one of sipe edges on both sides. In the present embodiment, the chamfered portion 20 can be, for example, formed by an inclined surface 20a extending between the ground contact surface of the land portion and a sipe wall. The inclined surface 20a can be, for example, disposed at an angle of 30 to 60° relative to the line, normal to the tire, passing through the ground contact surface of the land portion. A depth of the chamfered portion 20 can be, for example, 0.5 to 3.0 mm.

As shown in FIG. 3, the chamfered portion 20 can extend from the crown circumferential groove 3B to the shoulder circumferential groove 3A in a tread planar view. A first chamfered width W3 of the chamfered portion 20 at the end on the crown circumferential groove 3B side can be greater than a second chamfered width W4 of the chamfered portion 20 at the end on the shoulder circumferential groove 3A side. In the present disclosure, by adopting the above-described structure, braking performance can be enhanced while steering stability can be maintained.

As shown in FIG. 2, in the middle land portions 4A of the present disclosure, strain in the ground contact surface can be reduced by the middle sipes 15 having the chamfered portions 20, and, consequently, a ground contact pressure acting on the ground contact surface can be made uniform. Thus, braking performance and steering stability can be enhanced.

Furthermore, in the land portion disposed between the tire equator and the tread end as in the middle land portion 4A of the present disclosure, a higher ground contact pressure can tend to act on the ground contact surface on the tire equator side. In consideration of such a tendency, in the present disclosure, the first chamfered width W3 (shown in FIG. 3) of the chamfered portion 20 at the end on the crown circumferential groove 3B side can be greater than the second chamfered width W4 (shown in FIG. 3) of the chamfered portion 20 at the end on the shoulder circumferential groove 3A side. Thus, the chamfered width can be sufficiently assured on the tire equator side at which a ground contact pressure is relatively high, and excellent braking performance can be exhibited. Meanwhile, the chamfered width can be small on the tread end side at which a ground contact pressure is relatively low, and an area of the ground contact surface can be assuredly increased, so that steering stability can be effectively maintained. The tire 1 of the present disclosure can be assumed to enhance braking performance while maintaining steering stability through the above-described mechanism.

The configurations of the present embodiment will be described below in more detail. The configurations described below represent a specific mode of the present embodiment. Therefore, it is needless to say that the present disclosure can provide the above-described effect even when the configurations described below are not provided. In addition, even when any one of the configurations described below is independently applied to the tire according to the present disclosure having the above-described characteristics, performance improvement corresponding to each configuration can be expected. Furthermore, when some of the configurations described below are applied in combination, complex performance improvement corresponding to the configurations can be expected.

As shown in FIG. 2, the middle sipes 15 disposed in one of the paired middle land portions 4A and the middle sipes 15 disposed in the other of the paired middle land portions 4A can be inclined relative to the tire axial direction in the same direction. Specifically, the middle sipes 15 can include outer middle sipes 16 disposed in the outer middle land portion 13 and inner middle sipes 17 disposed in the inner middle land portion 12. The outer middle sipe 16 can be, for example, inclined in the right-upward direction relative to the tire axial direction. Hereinafter, this inclination direction may be expressed by “inclined in a first direction relative to the tire axial direction.” The inner middle sipe 17 can be, for example, inclined relative to the tire axial direction in the same direction as the outer middle sipe 16. However, the present disclosure is not limited thereto. Unless otherwise specified, the characteristics of the middle sipe 15 described herein can be applied to both the outer middle sipes 16 and the inner middle sipes 17.

The middle sipe 15 can be, for example, inclined at 20 to 30° relative to the tire axial direction. The middle sipe 15 having such a structure can allow a frictional force to be exerted also in the tire axial direction during running on a wet surface, and can contribute to enhancement of steering stability.

One pitch length P1 in the tire circumferential direction for the plurality of the middle sipes 15 can be, for example, greater than a width W5, in the tire axial direction, of a ground contact surface of the middle land portion 4A. Specifically, the one pitch length P1 for the middle sipes 15 can be 130% to 180% of the width W5 of the middle land portion 4A, for instance. Such an arrangement of the middle sipes 15 can enhance steering stability and wet performance in a well-balanced manner. The one pitch length can be or represent a distance in the tire circumferential direction between sipe center lines (line by which the sipe width is equally divided into two) of two sipes adjacent to each other in the tire circumferential direction.

As shown in FIG. 3, the middle sipe 15 can have the chamfered portion 20 at each of sipe edges on both sides. Thus, the above-described effect is more assuredly exhibited. It is needless to say that the structure of one chamfered portion 20 described herein can be applied to each of the two chamfered portions 20 disposed in one sipe.

The second chamfered width W4 can be 30% to 60% of the first chamfered width W3, for instance. Thus, steering stability and braking performance can be enhanced in a well-balanced manner.

Specifically, the first chamfered width W3 can be 1.5 to 3.0 mm, for instance. The second chamfered width W4 can be 0.5 to 1.5 mm, for instance. The minimum chamfered width of the chamfered portion 20 of the middle sipe 15 can be, for example, 0.3 to 1.0 mm. Thus, the above-described effect can be exhibited while uneven wear of the land portion is reduced.

The chamfered portion 20 can include, for example, a constant width portion 21, an inner increased-width portion 22, and an outer increased-width portion 23. The constant width portion 21 can extend with a constant chamfered width in the sipe length direction. The inner increased-width portion 22 can be, for example, continuous with the crown circumferential groove 3B side of the constant width portion 21, and can have a chamfered width increased continuously from the constant width portion 21 to the crown circumferential groove 3B.

The outer increased-width portion 23 can be, for example, continuous with the shoulder circumferential groove 3A side of the constant width portion 21, and can have a chamfered width increased continuously from the constant width portion 21 to the shoulder circumferential groove 3A.

As described above, in the present embodiment, the middle sipe 15 can have the chamfered portion 20 at each of sipe edges on both sides, and the chamfered portion 20 can include the inner increased-width portion 22 and the outer increased-width portion 23. In the present embodiment, even when a ground contact pressure is greatly changed, each of the middle land portions 4A can allow exhibition of excellent ground contact performance through a combination of such configurations, resulting in further enhancement of steering stability and braking performance.

As shown in FIG. 2, the constant width portion 21 can be, for example, disposed outwardly of the tire-axially center position of the middle land portion 4A, in the tire axial direction. Thus, a length L3, in the tire axial direction, of the inner increased-width portion 22 can be greater than a length L4, in the tire axial direction, of the outer increased-width portion 23. Specifically, the length L3 of the inner increased-width portion 22 can be 40% to 60% of the width W5 of the ground contact surface of the middle land portions 4A, for instance. The length L4 of the outer increased-width portion 23 can be 25% to 35% of the width W5 of the ground contact surface of the middle land portion 4A, for instance. Thus, even when a ground contact pressure acting on the middle land portion 4A is changed, the above-described effect can be assuredly exhibited.

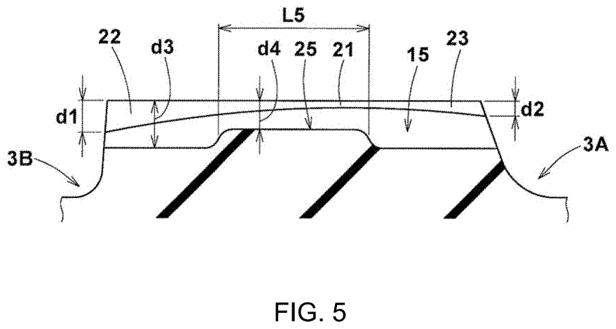

FIG. 5 is a cross-sectional view taken along a line B-B in FIG. 2. As shown in FIG. 5, the maximum depth d1 of the inner increased-width portion 22 can be greater than the maximum depth d2 of the outer increased-width portion 23. Specifically, the depth d2 of the outer increased-width portion 23 can be 20% to 60% of the depth d1 of the inner increased-width portion 22, for instance. The depth d1 of the inner increased-width portion 22 and the maximum depth d2 of the outer increased-width portion 23 can be, for example, each 0.5 to 3.0 mm. The minimum depth of the chamfered portion 20 can be, for example, 0.3 to 1.0 mm.

The middle sipe 15 can include, for example, a middle tie bar 25 having a locally raised bottom portion. The middle tie bar 25 can be, for example, disposed in the center of three regions in a case where the middle sipe 15 is equally divided into the three regions in the tire axial direction. A length L5, in the tire axial direction, of the middle tie bar 25 can be 30% to 50% of the width W5 (shown in FIG. 2), for instance, in the tire axial direction, of the ground contact surface of the middle land portion 4A. The minimum depth d4 from the ground contact surface of the middle land portion 4A to the outer surface of the middle tie bar 25 can be, for example, 60% to 90% of the maximum depth d3 of the middle sipe 15, such as 50% to 70% thereof. The maximum depth d3 of the middle sipe 15 can be, for example, 50% to 80% of the maximum depth of the shoulder circumferential groove 3A. The middle tie bar 25 having such a structure can allow stiffness of the middle land portion 4A to be maintained and can contribute to exerting a high cornering force.

As shown in FIG. 2, the center position, in the tire axial direction, of the crown land portion 14 can be displaced from the tire equator C toward the outer tread end To (shown in FIG. 1). Thus, in the crown land portion 14, a width W6b of a ground contact surface of an outer region 14b located between the outer tread end To and the tire equator C can be greater than a width W6a of a ground contact surface of an inner region 14a located between the inner tread end Ti and the tire equator C. Specifically, the width W6b of the outer region 14b can be 51% to 55% of a width W6 of a ground contact surface of the crown land portion 14, for instance. The crown land portion 14 having such a structure can allow change of a cornering force according to change of a steering angle to become linear, and can contribute to enhancement of steering stability and ride comfort.

The crown land portion 14 can include a plurality of first crown sipes 31 and a plurality of second crown sipes 32. For example, the first crown sipe 31 can extend from the inner crown circumferential groove 7 and can terminate in the crown land portion 14. For example, the second crown sipe 32 can extend from the outer crown circumferential groove 8 and can terminate in the crown land portion 14. The first crown sipe 31 and the second crown sipe 32 having such structures can reduce rolling resistance while maintaining wet performance.

In order to assuredly exhibit the above-described effect, each of the first crown sipe 31 and the second crown sipe 32 may not extend across the center position, in the tire axial direction, of the crown land portion 14, and may not extend across the tire equator C. A length L6, in the tire axial direction, of the first crown sipe 31 or the second crown sipe 32 can be, for example, 15% to 30% of the width W6, in the tire axial direction, of the ground contact surface of the crown land portion 14.

The first crown sipe 31 and the second crown sipe 32 can be, for example, inclined in the first direction relative to the tire axial direction. An angle of the first crown sipe 31 or the second crown sipe 32 relative to the tire axial direction can be, for example, 20 to 30°. According to one or more embodiments, an angular difference between the outer middle sipe 16 and the first crown sipe 31 or the second crown sipe 32 can be not greater than 10°. Thus, uneven wear of the crown land portion 14 can be reduced.

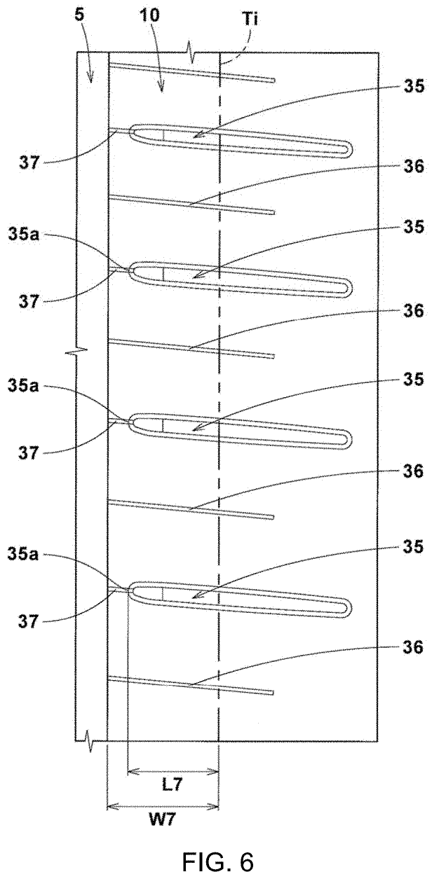

FIG. 6 is an enlarged view of the inner shoulder land portion 10. As shown in FIG. 6, the inner shoulder land portion 10 can include a plurality of inner shoulder lateral grooves 35 and a plurality of inner shoulder sipes 36. In the present embodiment, the inner shoulder lateral grooves 35 and the inner shoulder sipes 36 can alternate in the tire circumferential direction, though embodiments of the disclosed subject matter are not so limited.

The inner shoulder lateral groove 35 can extend from an inner end 35a disposed between the inner tread end Ti and the inner shoulder circumferential groove 5 beyond the inner tread end Ti. For example, the inner shoulder lateral groove 35 can extend across the center position, in the tire axial direction, of a ground contact surface of the inner shoulder land portion 10. A length L7, in the tire axial direction, of the inner shoulder lateral groove 35 at the ground contact surface of the inner shoulder land portion 10 can be, for example, 70% to 90% of a width W7, in the tire axial direction, of the ground contact surface of the inner shoulder land portion 10. The inner shoulder lateral groove 35 having such a structure can contribute to enhancing braking performance while maintaining wet performance.

The inner shoulder lateral groove 35 can be, for example, inclined in the right-downward direction relative to the tire axial direction. That is, in the present embodiment, the inner shoulder lateral groove 35 can be inclined relative to the tire axial direction in the direction opposite to that of the middle sipe 15. Hereinafter, this inclination direction may be expressed by “inclined in a second direction relative to the tire axial direction.” An angle of the inner shoulder lateral groove 35 relative to the tire axial direction can be, for example, 5 to 15°. The inner shoulder lateral groove 35 having such a structure can guide water thereinside toward the inner tread end Ti during running on a wet surface, and can exhibit excellent drainage performance.

The inner shoulder sipe 36 can extend from the inner shoulder circumferential groove 5 beyond the inner tread end Ti. For example, the inner shoulder sipe 36 can linearly extend so as to be inclined in the second direction relative to the tire axial direction. An angle of the inner shoulder sipe 36 relative to the tire axial direction can be, for example, 5 to 15°. An angular difference between the inner shoulder sipe 36 and the inner shoulder lateral groove 35 can be not greater than 10°, and, in the present embodiment, the inner shoulder sipe 36 and the inner shoulder lateral groove 35 can extend in parallel to each other, as but one example. The inner shoulder sipe 36 having such a structure can enhance noise performance and ride comfort while reducing uneven wear of the inner shoulder land portion 10.

The inner shoulder sipe 36 can include no chamfered portion. That is, the inner shoulder sipe 36 can have a sipe wall that is connected directly to the ground contact surface of the inner shoulder land portion 10, and that extends along the tire radial direction. The inner shoulder sipe 36 having such a structure can exert, with its edges, a high frictional force during running on a wet surface.

In the present embodiment, the inner shoulder land portion 10 can have an auxiliary sipe 37 that extends from the inner shoulder circumferential groove 5 to the inner end 35a of the inner shoulder lateral groove 35. The auxiliary sipe 37 having such a structure can contribute to maintaining wet performance.

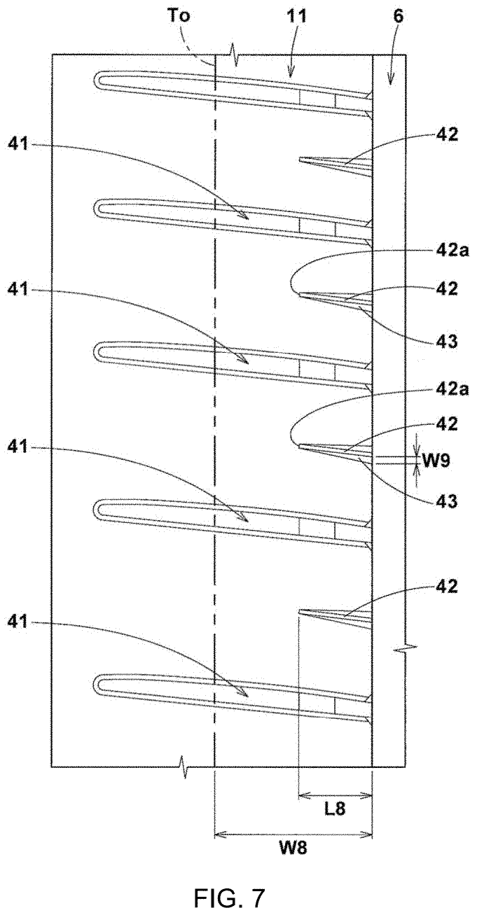

FIG. 7 is an enlarged view of the outer shoulder land portion 11. As shown in FIG. 7, the outer shoulder land portion 11 can include a plurality of outer shoulder lateral grooves 41 and a plurality of outer shoulder sipes 42. In the present embodiment, the outer shoulder lateral grooves 41 and the outer shoulder sipes 42 can alternate in the tire circumferential direction, though embodiments of the disclosed subject matter are not so limited.

The outer shoulder lateral groove 41 can extend from the outer shoulder circumferential groove 6 beyond the outer tread end To. The outer shoulder lateral groove 41 can be, for example, inclined in the second direction relative to the tire axial direction. That is, in the present embodiment, the outer shoulder lateral groove 41 can be inclined relative to the tire axial direction in the direction opposite to that of the middle sipe 15. An angle of the outer shoulder lateral groove 41 relative to the tire axial direction can be, for example, 5 to 15°. According to one or more embodiments, an angular difference between the outer shoulder lateral groove 41 and the inner shoulder lateral groove 35 (shown in FIG. 6) may be not greater than 10°, such as not greater than 5°.

The outer shoulder sipe 42 can extend from the outer shoulder circumferential groove 6 and can have a terminating end 42a between the outer shoulder circumferential groove 6 and the outer tread end To. A length L8, in the tire axial direction, of the outer shoulder sipe 42 can be, for instance, 40% to 60% of a width W8, in the tire axial direction, of a ground contact surface of the outer shoulder land portion 11.

The outer shoulder sipe 42 can be, for example, inclined in the second direction relative to the tire axial direction. An angle of the outer shoulder sipe 42 relative to the tire axial direction can be, for example, 5 to 15°. An angular difference between the outer shoulder sipe 42 and the outer shoulder lateral groove 41 can be not greater than 10°, and, in the present embodiment, the outer shoulder sipe 42 and the outer shoulder lateral groove 41 can extend in parallel to each other, for instance. The outer shoulder sipe 42 having such a structure can maintain wet performance while reducing uneven wear of the outer shoulder land portion 11.

In the present embodiment, the outer shoulder sipe 42 can have a chamfered portion 43 at each of sipe edges on both sides. According to one or more embodiments, the chamfered portion 43 can have a chamfered width increased from the terminating end 42a side toward the outer shoulder circumferential groove 6. Thus, a ground contact pressure acting on the outer shoulder land portion 11 can be made uniform, and steering stability and braking performance can be enhanced.

For example, a chamfered width of the chamfered portion 43 of the outer shoulder sipe 42 can continuously increase from the terminating end 42a side toward the outer shoulder circumferential groove 6. The maximum chamfered width W9 of the chamfered portion 43 can be, for example, 2.0 to 4.0 mm. In the present embodiment, the maximum chamfered width W9 can be formed at the end of the outer shoulder sipe 42 on the outer shoulder circumferential groove 6 side.

According to one or more embodiments, the maximum chamfered width W9 of the outer shoulder sipe 42 can be less than the first chamfered width W3 (shown in FIG. 3) of the chamfered portion 20 of the middle sipe 15, and can be greater than the second chamfered width W4 (shown in FIG. 3). Thus, uneven wear of each portion can be reduced.

In the present embodiment, each land portion may not include grooves and sipes other than the above-described grooves and sipes. Thus, the various performances described above are exhibited in a well-balanced manner. For instance, the crown land portion 14 may not include any sipes with a chamfered portion or portions (e.g., middle sipes 15) as described herein. However, the present disclosure is not limited thereto.

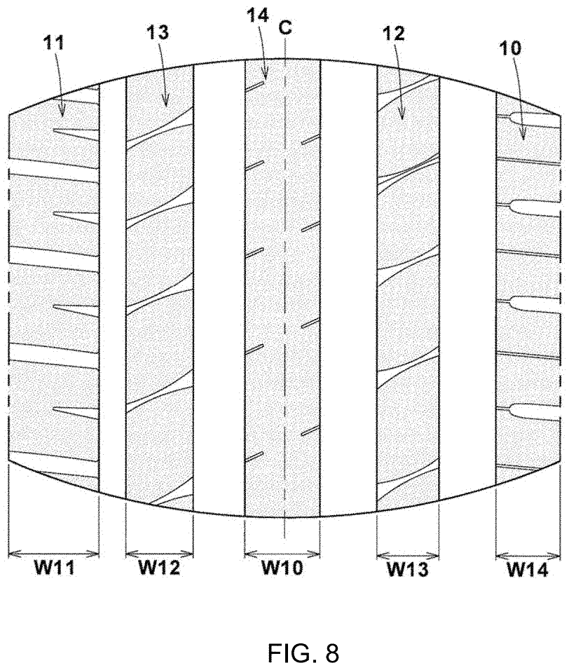

FIG. 8 shows a ground contact surface shape obtained when 50% of the normal load (hereinafter, may be referred to as “50% load state”) is applied to the tire 1 in the normal state. As shown in FIG. 8, in the 50% load state, a width W11, in the tire axial direction, of the ground contact surface of the outer shoulder land portion 11 can be, for instance, 114% to 124% of a width W10, in the tire axial direction, of the ground contact surface of the crown land portion 14.

Similarly, a width W12, in the tire axial direction, of a ground contact surface of the outer middle land portion 13 can be, for instance, 85% to 115% of the width W10, in the tire axial direction, of the ground contact surface of the crown land portion 14. The width W12, in the tire axial direction, of the ground contact surface of the outer middle land portion 13 can be greater than a width W13, in the tire axial direction, of a ground contact surface of the inner middle land portion 12. Specifically, the width W12 of the outer middle land portion 13 can be 105% to 115% of the width W13 of the inner middle land portion 12, for instance. Each of the width W13, in the tire axial direction, of the ground contact surface of the inner middle land portion 12 and a width W14, in the tire axial direction, of the ground contact surface of the inner shoulder land portion 10 can be, for instance, 80% to 100% of the width W10, in the tire axial direction, of the ground contact surface of the crown land portion 14. Thus, in a case where the tires 1 of the present embodiment are applied to all wheels of a vehicle, the front wheels and the rear wheels can exhibit cornering forces in a well-balanced manner, and excellent steering stability can be consequently exhibited.

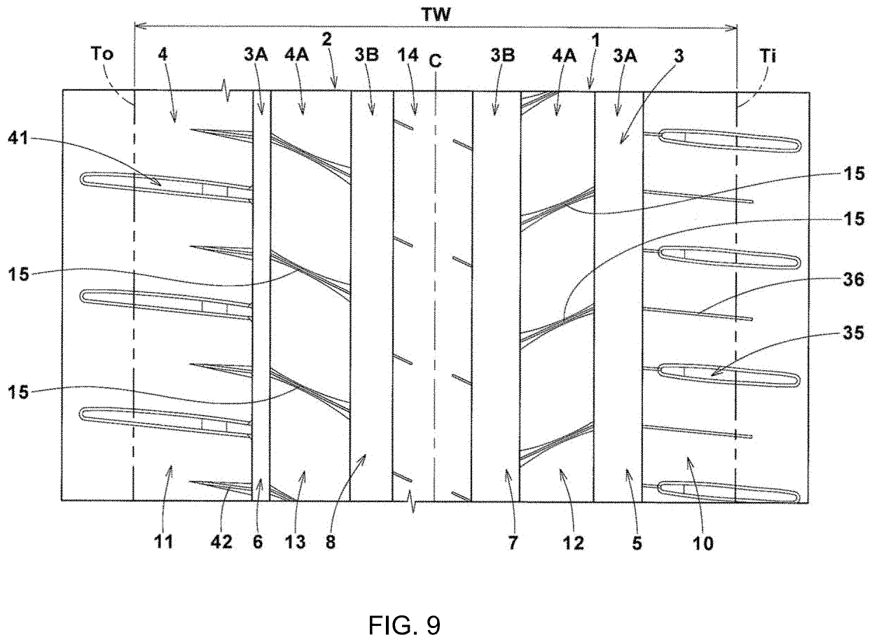

FIG. 9 is a development of a tread portion 2 according to another embodiment of the present disclosure. As shown in FIG. 9, the present embodiment is different from the embodiment shown in FIG. 1 in that, in the present embodiment, the outer middle sipes 16, and the first crown sipes 31 and the second crown sipes 32 can be inclined in the second direction relative to the tire axial direction. Thus, the middle sipes 15 disposed in one of the paired middle land portions 4A and the middle sipes 15 disposed in the other of the paired middle land portions 4A can be inclined relative to the tire axial direction in the opposite directions. Such an embodiment can contribute to enhancement of conicity of the tire 1. To the embodiment in FIG. 9, the structure described for the embodiment shown in FIG. 1 to FIG. 8 can be applied.

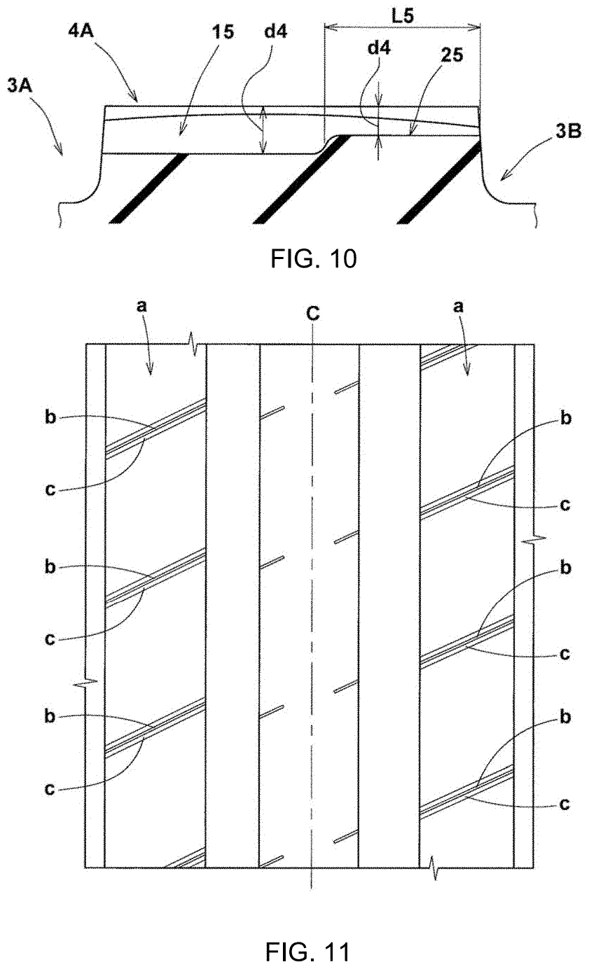

FIG. 10 is a cross-sectional view of the middle sipe 15 according to another embodiment of the present disclosure as taken along the length direction. As shown in FIG. 10, in the present embodiment, the middle sipe 15 can include a middle tie bar 25 having a locally raised bottom portion. In the present embodiment, the middle tie bar 25 can be, for example, disposed between the crown circumferential groove 3B and the center position, in the tire axial direction, of the ground contact surface of the middle land portion 4A. Specifically, the middle tie bar 25 can have the raised portion including the end portion, in the tire axial direction, of the middle sipe 15. The middle tie bar 25 having such a structure can enhance stiffness of the middle land portion 4A on the crown circumferential groove 3B side and can contribute to exhibiting excellent steering stability.

In still another embodiment, the middle tie bar 25 may be, for example, disposed between the shoulder circumferential groove 3A and the center position, in the tire axial direction, of the ground contact surface of the middle land portions 4A. In such an embodiment, stiffness of the middle land portion 4A on the shoulder circumferential groove 3A side can be enhanced, and, consequently, responsiveness to steering during cornering can become linear.

A length L5, in the tire axial direction, of the middle tie bar 25 can be, for instance, 30% to 50% of the width W5 (shown in FIG. 2), in the tire axial direction, of the ground contact surface of the middle land portions 4A. In a case where the length, in the tire axial direction, of the middle tie bar 25 varies in the tire radial direction, the length L5 can be measured at the center position in the tire radial direction. The minimum depth d4 from the ground contact surface of the middle land portion 4A to the outer surface of the middle tie bar 25 can be, for example, 60% to 90% of the maximum depth d3 of the middle sipe 15, such as 50% to 70% thereof. The maximum depth d3 of the middle sipe 15 can be, for example, 50% to 80% of the maximum depth of the shoulder circumferential groove 3A. The middle tie bar 25 having such a structure can contribute to well-balanced enhancement of steering stability and wet performance.

Although the tire according to the embodiments of the present disclosure has been described above in detail, the present disclosure is not limited to the above-described specific embodiments, and various modifications can be made to implement the technique of the present disclosure.

### Examples

Test tires having the basic pattern shown in FIG. 1 and a size of 235/45R19 were produced based on the specifications in Table 1. As a comparative example, a test tire having a pair of middle land portions a shown in FIG. 11 was produced. In the tire of the comparative example, each middle land portion a included middle sipes b each having a chamfered portion c extending with a constant chamfered width. The tire of the comparative example was substantially the same as the tire shown in FIG. 1 except for the above-described structure. For each test tire, steering stability and braking performance were tested. Specifications common to the test tires and test methods were as follows.

Rim on which the tire was mounted: 19×8.0 J

Tire internal pressure: 230 kPa

Test vehicle: four-wheel-drive vehicle having an engine displacement of 2000 cc

Positions at which the tires were mounted: all wheels

<Steering Stability>

A driver made sensory evaluation for steering stability when the test vehicle was caused to run on a dry road surface. The result is indicated as a score with the steering stability of the comparative example being 100. The greater the value is, the more excellent steering stability is.

<Braking Performance>

A driver made sensory evaluation for braking performance in various states when the test vehicle was caused to run on a dry road surface. The result is indicated as a score with the braking performance of the comparative example being 100. The greater the value is, the more excellent the braking performance is.

The test results are indicated in Table 1.

TABLE 1

| | Comparative | Example | Example | Example | Example | Example | Example | Example | Example | Example |
|---|---|---|---|---|---|---|---|---|---|---|
| | example | 1 | 2 | 3 | 4 | 5 | 6 | 7 | 8 | 9 |
| Figure showing middle | FIG. 11 | FIG. 2 | FIG. 2 | FIG. 2 | FIG. 2 | FIG. 2 | FIG. 2 | FIG. 2 | FIG. 2 | FIG. 2 |
| land portion | | | | | | | | | | |
| Second chamfered width | — | 45 | 30 | 40 | 50 | 60 | 40 | 40 | 40 | 40 |
| W4/first chamfered width | | | | | | | | | | |
| W3 (%) | | | | | | | | | | |
| Depth d2 of outer | — | 40 | 40 | 40 | 40 | 40 | 20 | 30 | 50 | 60 |
| increased-width | | | | | | | | | | |
| portion/depth d1 of | | | | | | | | | | |
| inner increased- | | | | | | | | | | |
| width portion (%) | | | | | | | | | | |
| Steering stability (score) | 100 | 103 | 104 | 103 | 102 | 101 | 104 | 103 | 103 | 102 |
| Braking performance | 100 | 108 | 104 | 106 | 108 | 108 | 106 | 107 | 108 | 108 |
| (score) | | | | | | | | | | |

Table 1 indicates that the steering stability indicated 101 to 104 points and the steering stability was thus maintained while the braking performance indicated 104 to 108 points and was thus enhanced in the tires of the examples. That is, the tire of the present disclosure was confirmed to enhance braking performance while maintaining steering stability.

### APPENDIXES

The present disclosure includes the following aspects. An object of the present disclosure, among multiple objects, can be to provide a tire that can enhance braking performance while maintaining steering stability.

### Disclosure 1

A tire includes a tread portion,

the tread portion includes four circumferential grooves extending continuously in a tire circumferential direction between two tread ends, and five land portions demarcated by the four circumferential grooves,

the four circumferential grooves include a pair of shoulder circumferential grooves, and a pair of crown circumferential grooves disposed between the pair of shoulder circumferential grooves,

the land portions include a pair of middle land portions each demarcated between a corresponding one of the shoulder circumferential grooves and a corresponding one of the crown circumferential grooves,

each middle land portion includes a plurality of middle sipes extending completely across the middle land portion in a tire axial direction,

each middle sipe has a chamfered portion at at least one of sipe edges on both sides,

the chamfered portion extends from a corresponding one of the crown circumferential grooves to a corresponding one of the shoulder circumferential grooves in a tread planar view, and

a first chamfered width of the chamfered portion at an end on the crown circumferential groove side is greater than a second chamfered width of the chamfered portion at an end on the shoulder circumferential groove side.

### Disclosure 2

In the tire according to disclosure 1, each middle sipe has the chamfered portion at each of the sipe edges on both the sides.

### Disclosure 3

In the tire according to disclosure 1 or 2, the chamfered portion includes an inner increased-width portion having a chamfered width increased continuously toward a corresponding one of the crown circumferential grooves.

### Disclosure 4

In the tire according to disclosure 3, the chamfered portion includes an outer increased-width portion having a chamfered width increased continuously toward a corresponding one of the shoulder circumferential grooves.

### Disclosure 5

In the tire according to disclosure 4,

the chamfered portion includes a constant width portion extending with a constant width between the inner increased-width portion and the outer increased-width portion, and

the constant width portion is disposed outwardly of a tire-axially center position of each middle land portion, in the tire axial direction.

### Disclosure 6

In the tire according to disclosure 4 or 5, a length, in the tire axial direction, of the inner increased-width portion is greater than a length, in the tire axial direction, of the outer increased-width portion.

### Disclosure 7

In the tire according to any one of disclosures 4 to 6, a maximum depth of the inner increased-width portion is greater than a maximum depth of the outer increased-width portion.

### Disclosure 8

In the tire according to any one of disclosures 1 to 7, the second chamfered width is 30% to 60% of the first chamfered width.

### Disclosure 9

In the tire according to any one of disclosures 1 to 8, the middle sipes disposed in one of the pair of middle land portions and the middle sipes disposed in another of the pair of middle land portions are inclined relative to the tire axial direction in opposite directions.

### Disclosure 10

In the tire according to any one of disclosures 1 to 8, the middle sipes disposed in one of the pair of middle land portions and the middle sipes disposed in another of the pair of middle land portions are inclined relative to the tire axial direction in a same direction.

### Disclosure 11

In the tire according to disclosure 10,

the tread portion includes an outer tread end located on an outer side of a vehicle when the tire is mounted to the vehicle, by designating a mounting direction to a vehicle,

the five land portions include an outer shoulder land portion including the outer tread end, and

the outer shoulder land portion includes a plurality of outer shoulder lateral grooves and a plurality of outer shoulder sipes that are inclined relative to the tire axial direction in a direction opposite to that of the middle sipes.

### Disclosure 12

In the tire according to disclosure 10 or 11,

the tread portion includes an inner tread end located on an inner side of a vehicle when the tire is mounted to the vehicle, by designating a mounting direction to a vehicle,

the five land portions include an inner shoulder land portion including the inner tread end, and

the inner shoulder land portion includes a plurality of inner shoulder lateral grooves and a plurality of inner shoulder sipes that are inclined relative to the tire axial direction in a direction opposite to that of the middle sipes.

### Disclosure 13

In the tire according to any one of disclosures 1 to 12, a maximum depth of each middle sipe is 50% to 80% of a maximum depth of each shoulder circumferential groove.

### Disclosure 14

In the tire according to any one of disclosures 1 to 13, each middle sipe includes a middle tie bar having a locally raised bottom portion.

### Disclosure 15

In the tire according to disclosure 14, a minimum depth from a ground contact surface of a corresponding one of the middle land portions to an outer surface of the middle tie bar is 60% to 90% of a maximum depth of each middle sipe.

### Disclosure 16

In the tire according to disclosure 14 or 15, a length, in the tire axial direction, of the middle tie bar is 30% to 50% of a width, in the tire axial direction, of a ground contact surface of each middle land portion.

### Disclosure 17

In the tire according to any one of disclosures 1 to 16, further comprising a crown land portion between the pair of crown circumferential grooves, wherein the crown land portion does not include any sipes with one or more chamfered portions.

### Disclosure 18

In the tire according to any one of disclosures 1 to 17, wherein the chamfered portion comprises a constant width portion extending with a constant width between the opposite first and second ends, and wherein the constant width portion is disposed outwardly of a tire-axially center position of each said middle land portion, in the tire axial direction, inward of the shoulder circumferential groove.

### Disclosure 19

The tire according to any one of disclosures 1 to 18, wherein all of the middle sipes per middle land portion are identical.

### Disclosure 20

A tire comprising:

a tread portion,

wherein the tread portion comprises four circumferential grooves extending continuously in a tire circumferential direction between two tread ends, and five land portions demarcated by the four circumferential grooves,

wherein the four circumferential grooves comprise a pair of shoulder circumferential grooves, and a pair of crown circumferential grooves disposed between the pair of shoulder circumferential grooves,

wherein the land portions comprise a plurality of land portions between the shoulder circumferential grooves,

wherein each land portion comprises a plurality of sipes extending completely across the land portion in a tire axial direction,

wherein each sipe has a chamfered portion at at least one of sipe edges on both opposite ends thereof,

wherein a first chamfered width of the chamfered portion at a first one of the opposite ends is greater than a second chamfered width of the chamfered portion at a second one of the opposite ends,

wherein each said sipe has the chamfered portion at each of the sipe edges at both the first and second opposite ends,

wherein the second chamfered width is 30% to 60% of the first chamfered width,

wherein the chamfered portion comprises a constant width portion extending with a constant width between the opposite first and second ends, and

wherein the constant width portion is inward of the first and second opposite ends of the sipe.

The tire of the present disclosure has the above-described structure, and, therefore, braking performance can be enhanced while steering stability is maintained.

What is claimed is:

1. A tire comprising:
a tread portion,
wherein the tread portion comprises four circumferential grooves extending continuously in a tire circumferential direction between two tread ends, and five land portions demarcated by the four circumferential grooves,
wherein the four circumferential grooves comprise a pair of shoulder circumferential grooves, and a pair of crown circumferential grooves disposed between the pair of shoulder circumferential grooves,
wherein the land portions comprise a pair of middle land portions each demarcated between a corresponding one of the shoulder circumferential grooves and a corresponding one of the crown circumferential grooves,
wherein each middle land portion comprises a plurality of middle sipes extending completely across the middle land portion in a tire axial direction,
wherein each middle sipe has a chamfered portion at at least one of sipe edges on both opposite ends thereof,
wherein the chamfered portion extends from a corresponding one of the crown circumferential grooves to a corresponding one of the shoulder circumferential grooves in a tread planar view,
wherein a first chamfered width of the chamfered portion at a first one of the opposite ends on a crown circumferential groove side is greater than a second chamfered width of the chamfered portion at a second one of the opposite ends on a shoulder circumferential groove side, and
wherein each said middle sipe has the chamfered portion at each of the sipe edges at both the first and second opposite ends.

2. The tire according to claim 1, further comprising a crown land portion between the pair of crown circumferential grooves,
wherein the crown land portion does not include any sipes with one or more chamfered portions.

3. The tire according to claim 1, wherein the chamfered portion comprises an inner increased-width portion having a chamfered width that increases continuously toward a corresponding one of the crown circumferential grooves.

4. The tire according to claim 3, wherein the chamfered portion comprises an outer increased-width portion having a chamfered width that increases continuously toward a corresponding one of the shoulder circumferential grooves.

5. The tire according to claim 4,
wherein the chamfered portion comprises a constant width portion extending with a constant width between the inner increased-width portion and the outer increased-width portion, and
wherein the constant width portion is disposed outwardly of a tire-axially center position of each said middle land portion, in the tire axial direction.

6. The tire according to claim 4, wherein a first length, in the tire axial direction, of the inner increased-width portion is greater than a second length, in the tire axial direction, of the outer increased-width portion.

7. The tire according to claim 4, wherein a first maximum depth of the inner increased-width portion is greater than a second maximum depth of the outer increased-width portion.

8. The tire according to claim 1, wherein the second chamfered width is 30% to 60% of the first chamfered width.

9. The tire according to claim 1, wherein the middle sipes disposed in a first one of the middle land portions of the pair of middle land portions and the middle sipes disposed in a second one of the middle land portions of the pair of middle land portions are inclined relative to the tire axial direction in opposite directions.

10. The tire according to claim 1, wherein the middle sipes disposed in a first one of the middle land portions of the pair of middle land portions and the middle sipes disposed in a second one of the middle land portions of the pair of middle land portions are inclined relative to the tire axial direction in a same direction.

11. The tire according to claim 10,
wherein the tread portion comprises an outer tread end located on an outer side of a vehicle when the tire is mounted to the vehicle, by designating a mounting direction to a vehicle,
wherein the five land portions comprise an outer shoulder land portion including the outer tread end, and
wherein the outer shoulder land portion comprises a plurality of outer shoulder lateral grooves and a plurality of outer shoulder sipes that are inclined relative to the tire axial direction in a direction opposite to that of the middle sipes.

12. The tire according to claim 10,
wherein the tread portion comprises an inner tread end located on an inner side of a vehicle when the tire is mounted to the vehicle, by designating a mounting direction to a vehicle,
wherein the five land portions comprise an inner shoulder land portion including the inner tread end, and
wherein the inner shoulder land portion comprises a plurality of inner shoulder lateral grooves and a plurality of inner shoulder sipes that are inclined relative to the tire axial direction in a direction opposite to that of the middle sipes.

13. The tire according to claim 1, wherein a first maximum depth of each middle sipe is 50% to 80% of a second maximum depth of each shoulder circumferential groove.

14. The tire according to claim 1, wherein each said middle sipe comprises a middle tie bar having a locally raised bottom portion.

15. The tire according to claim 14, wherein a minimum depth from a ground contact surface of a corresponding one of the middle land portions to an outer surface of the middle tie bar is 60% to 90% of a maximum depth of each said middle sipe.

16. The tire according to claim 14, wherein a length, in the tire axial direction, of the middle tie bar is 30% to 50% of a width, in the tire axial direction, of a ground contact surface of each said middle land portion.

17. The tire according to claim 1,
wherein the chamfered portion comprises a constant width portion extending with a constant width between the opposite first and second ends, and
wherein the constant width portion is disposed outwardly of a tire-axially center position of each said middle land portion, in the tire axial direction, inward of the shoulder circumferential groove.

18. The tire according to claim 1, wherein all of the middle sipes are linear in the tread planar view.

19. The tire according to claim 1, wherein all of the middle sipes per middle land portion are identical.

20. A tire comprising:
a tread portion,
wherein the tread portion comprises four circumferential grooves extending continuously in a tire circumferential direction between two tread ends, and five land portions demarcated by the four circumferential grooves,
wherein the four circumferential grooves comprise a pair of shoulder circumferential grooves, and a pair of crown circumferential grooves disposed between the pair of shoulder circumferential grooves,
wherein the land portions comprise a plurality of land portions between the shoulder circumferential grooves,
wherein each land portion comprises a plurality of sipes extending completely across the land portion in a tire axial direction,
wherein each sipe has a chamfered portion at at least one of sipe edges on both opposite ends thereof,
wherein a first chamfered width of the chamfered portion at a first one of the opposite ends is greater than a second chamfered width of the chamfered portion at a second one of the opposite ends,
wherein each said sipe has the chamfered portion at each of the sipe edges at both the first and second opposite ends,
wherein the second chamfered width is 30% to 60% of the first chamfered width,
wherein the chamfered portion comprises a constant width portion extending with a constant width between the opposite first and second ends, and
wherein the constant width portion is inward of the first and second opposite ends of the sipe.
